(19) United States
(12) Patent Application Publication
(10) Pub. No.: US 2018/0127575 A1
(43) Pub. Date: May 10, 2018

(54) PROCESS FOR IMPROVING THE COLD-FLOW PROPERTIES OF PARAFFINIC OILS

(71) Applicant: GENERAL ELECTRIC COMPANY, SCHENECTADY, NY (US)

(72) Inventor: Kelly Scott Chichak, Clifton Park, NY (US)

(21) Appl. No.: 15/386,676

(22) Filed: Dec. 21, 2016

Related U.S. Application Data
(60) Provisional application No. 62/270,207, filed on Dec. 21, 2015.

(51) Int. Cl. C08L 33/10; C08L 33/08

(52) U.S. Cl. CPC C08L 33/10; C08L 33/08; C10G 2300/1085; C08F 2800/20; C08F 2438/01; C08F 2438/03; C10G 2300/304

(57) ABSTRACT

A process for improving the cold-flow properties of an oil that contains at least one paraffinic hydrocarbon material is described. The process includes the step of contacting the oil with a gradient copolymer formed by a controlled free-radical polymerization technique, or by a reversible deactivation radical polymerization technique. The gradient copolymer includes at least one polymer chain having both an alkylacrylate monomeric unit and an alkyl(meth)acrylate monomeric unit. The polymer chain is further characterized by a gradual transition in monomeric composition between the alkylacryalte unit and the alkyl(meth)acrylate unit. At least one of the alkylacrylate or alkyl(meth)acrylate monomeric units contains at least one pendant alkyl chain of 12 or more carbon atoms. A related method of transporting petroleum crude oil that contains dissolved wax through a pipeline is described, employing the gradient copolymer set for in this disclosure.

### CROSS-REFERENCE TO RELATED APPLICATIONS

The present Application claims priority to U.S. Provisional Application 62/270,207, filed on Dec. 21, 2015, the entire contents of which are incorporated by reference herein.

### TECHNICAL FIELD

This disclosure relates to oils, such as crude oil and middle distillates. More specifically, the disclosure is directed to new polymeric compositions for improving the cold-flow properties of such oils.

### BACKGROUND

Crude oil, or petroleum, is made up of hydrocarbons of various molecular weights, as well as other organic compounds. The recovery of petroleum by methods such as drilling also requires the successful transportation of the material through various piping systems, from an oil reservoir to the point of sale or storage. The ability or measure of flow through the pipes is sometimes referred to as “flow assurance”.

Fuels like those mentioned above sometimes contain various amounts of deposits, such as paraffins (waxes) and asphaltenes. Under reduced temperatures, these materials may crystallize out as platelet-shaped crystals, and may agglomerate with the inclusion of oil. This in turn impairs the flow of oil, lowering the flow assurance, and resulting in serious problems during the recovery, transport, storage and/or use of the oil. In some instances, the paraffin materials, forming deposits on the pipeline walls, can completely block the pipeline. The problem is especially difficult when the source of oil is remote. For example, new oil reservoirs are increasingly found in sub-sea locations, with much longer transportation lines needed for oil recovery. Furthermore, oil found in remote locations is sometimes heavier and waxier than oil found in conventional locations, adding to the difficulties in transportation. Moreover, the remote locations often mean that the oil will need to move through a colder environment than has normally been experienced, and this can be an additional problem for flow assurance.

A number of traditional techniques have been used to eliminate or reduce crystallized paraffins and other deposits. Physical or mechanical removal of deposits that have formed in pipelines is sometimes undertaken. In other cases, pipelines and vessels that contain the oil can be heated to reduce the viscosity of the oil, and improve its flow. Moreover, other prior art techniques involve the addition of solvents to reduce viscosity and improve oil flow.

While each of these techniques may be useful in some cases, there are often drawbacks to their use as well. For example, the heating and mechanical-removal techniques can be expensive and impractical—especially for long pipelines extending from remote locations or from other sites with challenging access. Moreover, the solvent dilution technique can also increase costs—both for the cost of the solvent, as well as the effort needed in eventually separating the additional volume of fluid from the desired petroleum product.

In addition to the classical methods for eliminating crystallized paraffins and other types of deposits, the use of chemical additives has received much greater attention over the years. In general, the additives interact physically with the precipitating crystals like the paraffins, modifying their shape, size or adhesion (i.e., adhesion to pipeline walls). Many of the additives function as additional crystal nuclei, resulting in an increased number of relatively small paraffin crystals having a modified crystal shape that allows for better movement through a pipeline or other passageway.

While the use of chemical additives has had some success in recent years, drawbacks remain. For example, the additives are sometimes not able to favorably react with all of the different types of compounds that decrease flow assurance in a pipeline. This may be due to the chemical structure of the additives in some cases, and to the fact that new sources and types of oil may include new and different paraffinic compounds and other impurities. Moreover, many of the additives can be expensive, due in part to the steps needed in preparing them on a commercial basis.

Furthermore, additives that functioned reasonably well in a typical setting for oil drilling and recovery may function poorly in more challenging and hostile environments. For example, the additives may need to be directed through umbilical conduits that are deployed for subsea oil and gas wells developed in remote locations. Such locations may be characterized by exceptionally low temperatures (4° C.) and high pressures that could greatly diminish the performance attributes of the additives, e.g., causing them to gel or solidify within the umbilicals.

With these considerations in mind, new materials and processes for improving the cold flow properties of various oils would be welcome in the art. In some specific cases, the new materials should be very effective in interacting with the paraffinic compounds that impede flow in various oils. In this regard, the new materials should be capable of being effectively matched to at least some of the characteristics of the paraffinic compounds in the oils, to enhance chemical and physical interaction. Moreover, the new materials should be relatively easy and cost-effective to manufacture, and to be incorporated into an oil treatment process.

### SUMMARY

Embodiments of the invention are directed to a process for improving the cold-flow properties of an oil that contains at least one paraffinic hydrocarbon material. The process comprises the step of contacting the oil with a gradient copolymer formed by a controlled free-radical polymerization technique, or by a reversible deactivation radical polymerization technique. The gradient copolymer comprises at least one polymer chain having both an alkylacrylate monomeric unit and an alkyl(meth)acrylate monomeric unit. The polymer chain is further characterized by a gradual transition in monomeric composition between the alkylacryalte unit and the alkyl(meth)acrylate unit. At least one of the alkylacrylate or alkyl(meth)acrylate monomeric units contains at least one pendant alkyl chain of 12 or more carbon atoms.

Another embodiment is directed to a method of transporting petroleum crude oil that contains dissolved wax through a pipeline, comprising the steps of contacting the crude oil with a gradient copolymer formed by a controlled free-radical polymerization technique or by reversible deactivation radical polymerization; so as to form a treated oil composition that exhibits improved flow properties (as compared to the untreated oil); and then pumping the treated oil composition through the pipeline to a desired location. The gradient copolymer is described in this disclosure.

### BRIEF DESCRIPTION OF THE DRAWINGS

FIG. 1 is a graph depicting average carbon number as a function of weight percent, for four exemplary linear alcohols used in embodiments of the invention.

FIG. 2 is a simplified depiction of gradient copolymers prepared according to embodiments of this invention.

FIG. 3 includes two graphs that depict flow point and wax appearance temperature (WAT) values as a function of carbon lengths for various gradient copolymers described in this disclosure.

FIG. 4 is a graph depicting manual gel point detection for a range of gradient copolymers.

FIG. 5 is a graph related to rheological data depicting the relationship between a decrease in temperature and an increase in viscosity for a number of gradient copolymers.

FIG. 6 is a graph related to the rheological data described for FIG. 5, comparing a fully-acrylate random copolymer with a gradient copolymer according to this invention.

### DETAILED DESCRIPTION

Approximating language, as used herein throughout the specification and claims, may be applied to modify any quantitative representation that could permissibly vary without resulting in a change in the basic function to which it is related. Accordingly, a value modified by a term or terms, such as “about”, and “substantially” is not to be limited to the precise value specified. In some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

In the following specification and the claims, the singular forms “a”, “an” and “the” include plural referents unless the context clearly dictates otherwise. As used herein, the term “or” is not meant to be exclusive and refers to at least one of the referenced components being present and includes instances in which a combination of the referenced components may be present, unless the context clearly dictates otherwise.

A variety of oils can be treated according to embodiments of this invention. Non-limiting examples include the many different types of heavy crude oil and light crude oil, mineral oil, and shale oils. All of the oils being treated would contain some level of paraffinic hydrocarbon material, also referred to as “wax” material. In some embodiments, the oils being treated contain about 1% by weight to about 65% by weight paraffin (both n-paraffinic compounds and iso-paraffinic compounds). Other components may be present as well, such as naphthalenes, polyaromatics, bitumen, sulfur, nitrogen, oxygen; and asphaltenes. Often, the paraffinic hydrocarbon material in the oil contains at least one alkyl chain of an average carbon length of 20 or more carbon atoms. As further described below, the pendant alkyl chain on the alkylacrylate or alkyl(meth)acrylate monomeric units of the gradient copolymer preferably matches the carbon length of the paraffinic material, within about 20% of the carbon chain length.

As mentioned above, the oil to be treated is contacted by a gradient copolymer. The manner of contact is not critical, and will depend in large part on the type of oil, and its location. In most instances, the gradient copolymer can be incorporated directly into the oil as an additive, dissolved in an appropriate solvent and injected into the crude oil stream.

The gradient copolymers of this invention comprise monomer units of formula (I)

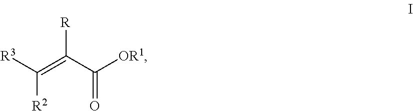

wherein R is hydrogen or methyl; R¹ is a linear or branched alkyl radical having from 5 to 60 carbon atoms; and R² and R³ are independently hydrogen or linear, or branched alky groups having 1 to 5 carbon atoms. A wide variety of compounds conforming to formula I could be used. Many of them are described in U.S. Pat. No. 8,163,682 (Stoehr et al), incorporated herein by reference.

In preferred embodiments, the gradient copolymer contains at least one alkylacrylate monomeric unit and at least one alkylmethacrylate (sometimes termed “alkyl(meth)acrylate”) monomeric unit. The monomeric precursors to the copolymers are well-known in the art, as are techniques for making the precursors. The alkyl group for each monomeric unit can contain up to about 5 carbon atoms. However, in most embodiments, the alkyl group is methyl, providing methylacrylate and methyl(meth)acrylate monomeric units.

As further described below, the polymerization process and the selection of monomer proportions results in a range of random and gradient copolymers based on the alkylacrylate and alkyl(meth)acrylate monomeric units. In many preferred embodiments, the polymer chain is characterized by a gradual transition in monomeric composition between the alkylacryalte unit and the alkyl(meth)acryalte unit. The ability to provide a gradient characteristic to the polymer chain can be important in matching the copolymer to one or more paraffinic components in the oil being treated, as discussed below.

As used here, the term “gradient copolymer” is meant to describe a copolymer which exhibits a gradual change in monomer composition from predominantly one species of monomer to predominantly another species of monomer. (See, for example, the article entitled “Gradient Polymers and Copolymers”, by Kryszewski, M (1998), from “Polymers for Advanced Technologies” (John Wiley & Sons, Ltd.) 9: 224-259. In some cases, the change-in-composition for gradient copolymers can be generally expressed by a mathematical expression,

g(X)=dF₁(X)/dX (II),

where g(X) represents the local composition gradient fraction; F₁ is the molar fraction of the first monomer unit; and X is the degree of polymerization. (See, for example, “Gradient Copolymers with Broad Glass Transition Temperature Regions: Design of Purely Interphase Compositions for Damping Applications”, by Mok, Michelle; Jungki Kim; John M. Torkelson (2008), Journal of Polymer Science (Wiley Periodicals, Inc.) 46: 48-58.).

The ratio between the alkylacrylate monomer and the alkyl(meth)acrylate monomer in the gradient copolymers of this invention can vary, based on a number of factors. They include the particular monomers being used; and the desired ratio of monomers, which can be used to calculate the effective average carbon number of the side chain brushes along the entire length of the polymer. The average carbon number of the brush side chain can be used to formulate a crude oils-intrinsic average carbon number distribution of paraffins. The crude oil average carbon number distribution is assesed with high temperature gas chromatography. Other factors include the desired molecular weight of the copolymer; and the molecular weight and composition of the paraffinic material(s) in the oil being treated. Usually, the weight-ratio will be in the range of about 5:95 to about 95:5. In some preferred embodiments, the ratio will be in the range of about 15:85 to about 85:15.

As mentioned above, at least one of the monomeric units in the gradient copolymer includes at least one pendant alkyl chain containing 20 or more carbon atoms (and in some cases, 40 or more carbon atoms). In most embodiments, there are a number of pendant chains, often referred to herein as “sidechains”, attached to the monomeric units. The sidechains can have different lengths, and can be purposefully arranged in a desired pattern to increase the effectiveness of the copolymer in treating oils.

Copolymers with chains containing a pattern of sidechains attached to the various monomer blocks are often referred to as “brush copolymers”. In some specific embodiments for the presently-described copolymers, at least about 50% of the sidechains contain more than 30 carbon atoms. In other embodiments, the pendant alkyl chain on the alkylmethacryalte monmeric unit (e.g., a methyl methacrylate unit) contains 40 or more carbon atoms.

The branched, gradient copolymers of this invention are prepared by the use of a controlled free-radical polymerization technique. This type of technique, based on the concept of “living” polymerization, can provide gradient copolymers that have highly specific sidechain configurations. The products are also characterized by a highly-controlled molecular weight, and a narrow molecular weight distribution.

Several techniques in this category are known in the art. For example, a nitroxide-mediated polymerization (NMP) process could be undertaken. NMP is a type of radical polymerization that makes use of an alkoxyamine initiator to generate polymers with well-controlled stereochemistry and a very low polydispersity index. (Alkoxyamines are alcohols that are bound to a secondary amine by a nitrogen-oxygen, N—O, single bond). The technique is sometimes referred to as “reversible-deactivation radical polymerization”. The process is described in a number of references, such as U.S. Pat. No. 4,581,429 (Solomon et al), incorporated herein by reference. Instructive information is also found in the “Handbook of Radical Polymerization”, by K. Matyjaszewski and T. P. Davis, Wiley Interscience, Hoboken 2002.

Details regarding NMP can also be found in “Alkoxyamine-Initiated Living Radical Polymerization: Factors Affecting Alkoxyamine Homolysis Rates”, by G. Moad et al, Macromolecules 1995, pp. 8722-8728 (1995), which is incorporated herein by reference. According to theory, functional groups on the alkoxyamine, such as a C—O bond, can be subjected to homolysis, yielding a stable radical in the form of a 2-center, 3-electron N—O system, along with a carbon radical that serves as an initiator for radical polymerization. The “R” groups attached to nitrogen are bulky, sterically hindering groups. The R group in the oxygen (O—) position forms a stable benzylic radical, allowing polymerization to occur successfully.

Another type of controlled free-radical polymerization technique suitable for embodiments of this invention is known as reversible addition fragmentation chain transfer polymerization, or “RAFT”. This technique is known in the art, and described, for example, in U.S. Pat. Nos. 9,169,383; 6,855,840; and WO 98/01478, all incorporated herein by reference. The RAFT techniques usually employ a chain transfer agent, such as a thiocarbonylthio compound. The use of this type of chain transfer agent can lead to very close control over the molecular weight of the generated copolymer, and contol over its polydispersity.

Although the present inventor does not want to be bound by this theory, it appears that the RAFT process functions by suppressing termination reactions through the addition of a suitable thiocarbonylthio compound, also known as a dithioester, to an otherwise conventional free radical polymerization. Control in such a RAFT process is thought to be achieved through a degenerative chain transfer mechanism in which a propagating radical reacts with the thiocarbonylthio compound to produce an intermediate radical species. This process decreases the number of free radicals available for termination reactions that require two free radicals, i.e., thereby promoting “living” polymerization. (U.S. Pat. No. 6,750,305 (Gateau et al) and U.S. Pat. No. 6,218,490 (Brunelli et al) are also instructive in regard to polymer additives for inhibiting paraffin deposition in crude oil, and are both incorporated herein by reference).

In a typical RAFT polymerization, an initiator is added to a heated solution that contains a first monomer, a solvent, and a suitable trithiocarbonate RAFT agent, as described in U.S. Pat. No. 9,169,383. In the present case, the first monomer could be an alkyl(meth)acrylate containing one or more pendant alkyl chains, as described elsewhere herein. As the reaction moves to completion, a solution containing a second monomer block, e.g., an acrylate block, can be added to the solution of the first monomer, followed by additional heating. The lengths of the first and second blocks are determined by the degree of polymerization of each segment, and can be individually controlled. Moreover, the progress of the overall reaction can be monitored by standard analytical techniques, e.g., NMR.

Another type of controlled free-radical polymerization technique suitable for embodiments of this invention is known as atom transfer radical polymerization (ATRP). ATRP is a type of transition metal-mediated atom transfer radical addition reaction, and is often preferred for the present invention. In this technique, carbon-carbon bonds are formed under typical radical polymerization mechanisms, but the rates of polymerization are controlled through a transition metal catalyst. The atom transfer step is a key step in the reaction, responsible for uniform polymer chain growth. The technique can be thought of as a living radical polymerization. In brief, the gradient copolymer according to this technique is usually prepared by polymerizing the unsaturated precursors to an alkylacrylate monomer and an alkyl(meth)acrylate monomer, in the presence of the initiator/catalyst/ligand constituents described below.

ATRP techniques are described in considerable detail in various references. Examples include U.S. Pat. No. 5,763,548 (Matyjaszewski et al); U.S. Pat. No. 6,391,996 (Scherer et al); and U.S. Pat. No. 8,163,682 (Stoehr et al), all incorporated herein by reference. The techniques employ a polymerization initiator that contains a transferable atomic group. Many of these initiators conform to the formula Y—(X)ₘ, wherein Y represents a starting molecule capable of forming radicals; X represents a transferable atom or a transferable atomic group; and “m” is a whole number in the range of 1 to 10, depending on the functionality of group Y. As described in the Scherer reference, the initiators usually must contain one or more atoms or atomic groups that are radically transferable under the polymerization techniques being used to carry out the reaction.

Non-limiting examples of polymerization initiators are benzyl halides like p-chloromethyl styrene; α-dichloroxylene, α,α-diochloroxylene, α,α-dibromoxylene, and hexakis (α-bromomethyl)benzene; benzyl chloride; benzyl bromide; 1-bromo-1-phenylethane; and 1-chloro-1-phenylethane; carboxylic acids derivatives that are halogenated in the α position, such as propyl 2-bromopropionate; methyl 2-chloropropionate; ethyl 2-chloropropionate; methyl 2-bromopropionate; and ethyl 2-bromoisobutyrate (EBiB); tosyl halides such as p-toluenesulfonyl chloride; alkyl halides like tetrachloromethane, tribromomethane, 1-vinylethyl chloride, 1-and vinylethyl bromide; and halogen derivatives of phosphoric acid esters, such as dimethylphosphoric chloride.

The amount of initiator can vary. It is generally used at a concentration in the range of about 10⁻⁴ mol/L to 3 mol/L. In some specific embodiments, the level is in the range of about 10⁻³ mol/L to 10⁻¹ mol/L. As those skilled in the art understand, the molecular weight of the copolymer is dependent on the ratio of initiator to monomers used.

The ATRP technique also employs at least one catalyst that contains a transition metal. In general, any transition metal compound that can produce a redox (reduction-oxidation) cycle with the initiator, or with the polymer chain that has a transferable atomic group, can be used. Mechanistically, the transferable atomic group and the catalyst reversibly form a compound, with the degree of oxidation of the transition metal being increased or decreased.

Some of the specific transition metals that can be used are Cu, Fe, Co, Cr, Ne, Sm, Mn, Mo, Ag, Zn, Pd, Pt, Re, Rh, Ir, In, Y, and/or Ru, which are used in appropriate degrees of oxidation. These metals can be used individually or as mixtures. It is assumed that these metals catalyze the redox cycles of the polymerization, with the redox pairs Cu⁺/Cu⁺² or Fe⁺²/Fe⁺³, for example, being active. In many instances, the metal compounds are added to the reaction mixture as halides, such as chloride or bromide, or as alkoxide, hydroxide, oxide, sulfate, phosphate, hexafluorophosphate, or trifluoromethane sulfate. Some of the specific metallic compounds that can be employed are Cu₂O, CuBr, CuBr₂, CuCl, CuI, CuN₃, CuSCN, CuCN, CuNO₂, CuNO₃, CuBF₄, Cu(CH₃COO), Cu(CF₃COO), FeBr₂, RuBr₂, CrCl₂, and NiBr₂.

Other compounds can also be used as the ATRP catalyst, e.g., those in higher oxidation states. Examples include CuO, CuBr₂, CuCl₂, CrCl₃, Fe₂O₃; and FeBr₃. In some cases, the transition metal compounds are reduced at first, because they are reacted with the radicals generated from the classical radical formers. Examples include 2,2′-azobisisobutyronitrile (AIBN); 1,1′-azobis(cyclohexanecarbonitrile); 2,2′-azobis(2,4-dimethylvaleronitrile); dimethyl 2,2-azobis(2-methylpropionate); benzoyl peroxide; and lauroyl peroxide. In some preferred embodiments, copper compounds are used as the catalyst, e.g., a combination of CuBr and CuBr₂. Additional information regarding catalysts suitable for the ATRP process can be found in the Scherer reference noted above.

The amount of transition metal catalyst present will depend on various factors, such as the amount and type of acrylate monomer units present; the type of initiator used; and the selected side-chain type and length.

In some specific embodiments, the molar ratio of transition metal to initiator is in the range of about 0.0001:1 to about 10:1. In some preferred embodiments, the range is about 0.01:1 to about 5:1.

The ATRP technique also employs at least one ligand that is capable of forming a coordination compound with the transition metal . The ligands perform a number of key functions, including increasing the solubility of the transition metal compound, as described in the Scherer reference. The ligands also function to prevent the formation of stable organometallic compounds, which otherwise might impede polymerization under the selected reaction conditions for forming the copolymer.

Examples of suitable ligands can be found, for example, in WO 97/18247 and WO 98/40415. These compounds in general have one or more nitrogen, oxygen, phosphorus and/or sulfur atoms, through which the metal atom of the catalyst can be bonded. Some non-limiting examples of suitable ligands are as follows: triphenylphosphane; 2,2-bipyridine; alkyl-2,2-bipyridine; 4,4-di-(5-nonyl)-2,2-bipyridine; 4,4-di-(5-heptyl)-2,2 bipyridine; tris(2-aminoethyl)amine (TREN); N,N,N′,N′,N″-pentamethyldiethylenetriamine (referred to as PMDTA or PMDETA); 1,1,4,7,10,10-hexamethyltriethylenetetraamine; N,N,N′,N′-tetrakis(2-pyridylmethyl)ethylenediamine (TPyEN); sparteine; triphenylphosphine; tetramethylethylenediamine (TMEDA); and combinations thereof.

The ligands can be used individually or as a mixture. Moreover, the ligands can form coordination compounds in situ with the metal catalyst compounds; or they can be prepared initially as coordination compounds, and then added to the reaction mixture. The amount of ligand used will depend on various factors. In general, the ratio of ligand to transition metal (from the catalyst) is dependent on the structure of the ligand; and on the coordination number of the transition metal. In some embodiments, the molar ratio is in the range of about 100:1 to about 0.1:1. More specifically, the ratio is usually in the range of about 6:1 to about 0.1:1. It should also be noted that in some cases, the overall ratio (molar) of initiator, transition metal catalyst, and ligand is about 1:1:1.

As mentioned above and further described below, the use of ATRP and the other controlled polymerization techniques described herein results in gradient materials that can be referred to as “brush-(co)polymers”, of varying compositional makeup. In addition to a selected gradient and concentration of acrylate and meth(acrylate) monomeric blocks, most embodiments include multiple, relatively long, alkyl sidechains attached to the monomeric blocks. Substantially all of the alkyl chains contain 20 or more carbon atoms. In some specific embodiments, substantially all of the alkyl chains have a pendant chain length in the range of about 20 to about 50 carbon atoms.

In some embodiments, the alkyl(meth)acrylate monomeric unit of the gradient copolymer is a methyl(meth)acrylate-based wax, having a pendant sidechain length in the range of about 20 to about 50 carbon atoms. In some preferred embodiments, the chain contains 40 or more carbon atoms. A wax material such as this can be formed by the esterification of methacrylic acid and a linear alcohol having at least about 20 carbon atoms (and sometimes at least about 40 carbon atoms), as also described herein. (It is again noted that alkylacrylate monomer unit can also contain pendant sidechains of these same lengths, made, for example, by the esterification of acrylic acid and a selected linear alcohol).

Many suitable linear alcohols are available in the prior art. Non-limiting examples include lauryl alcohol, cetyl alcohol, stearyl alcohol, behenyl alcohol, myristyl alcohol, oleyl alcohol, and cetostearyl alcohol. Mixtures of alcohols are also possible, such as the alcohol mixtures manufactured by SASOL, i.e., the alcohol blends of ISOFOL™, NAFOL™, NACOL™, and ALFOL™. (See http://sasolnorthamerica.com/Images/Interior/productsearchdocuments/sasolalcoholportfo liotechbulletin.pdf), the contents of which are incorporated herein by reference. Commercial sources for these alcohols include Rhodia, BASF, Henkel, SASOL, and Baker Hughes (Petrolite). Selection of a particular linear alcohol will depend on various physical properties such as viscosity, boiling point, and melting point; as well as the desired chain length(s) for side chains attached to the alkylacrylate and alkyl(meth)acrylate monomers.

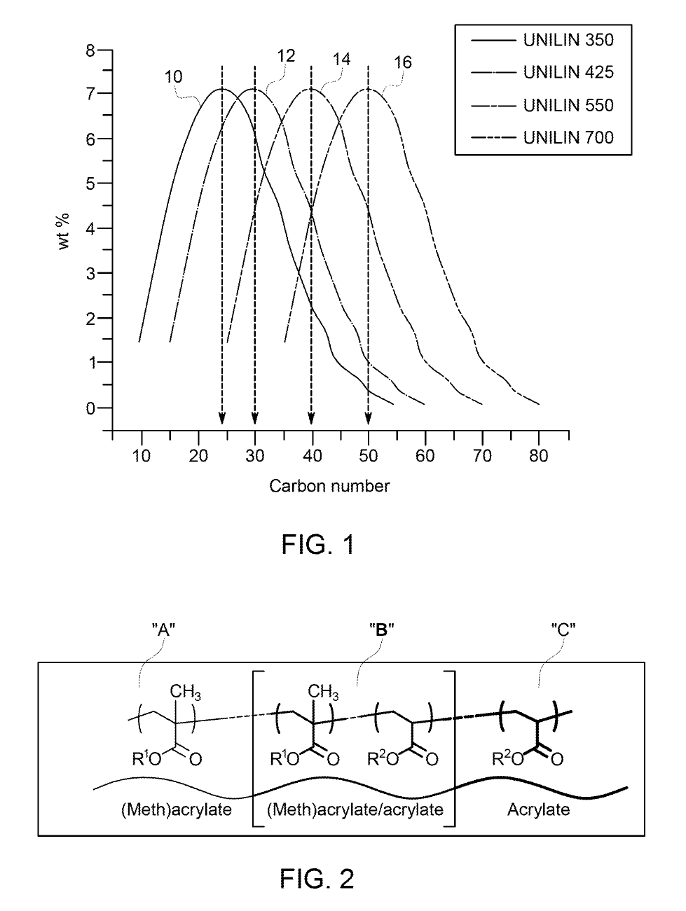

One convenient source for these materials is the Unilin®series of linear alcohols and derivatives thereof, from Baker Hughes. These alcohols are available in a wide range of carbon chain lengths. FIG. 1 lists four exemplary Unilin® alcohols—10, 12, 14, and 16. For each alcohol, the average carbon number is expressed as a function of weight percent.

Methods for preparing acrylate and (meth)acrylate-modified waxes, using linear alcohols like the Unilin® materials, are known in the art. In most embodiments, they are prepared by the esterification of the corresponding carboxylic acids (of the acrylics) with the desired linear alcohols. The reaction is carried out under acid conditions.

It should be understood that the pendant alkyl chains extending from one or more of the alkylacrylate units or alkyl(meth)acrylate units in the gradient copolymer are interchangeable. Either carbon branch can be distributed along the backbone of the copolymer, and a formulator has the ability to choose which sidechain can be attached to either of the monomers forming the copolymer. As a non-limiting example, a 25-carbon chain (C₂₅) acrylate-gradient-C₁₈ methacrylate copolymer falls within the scope of this invention, as does an 18-carbon (C₁₈)-acrylate-gradient-C₂₅ methacrylate copolymer. As shown in this disclosure, including the examples which follow, choice of particular chain segments and chain locations will depend on the desired properties for the overall gradient copolymer.

FIG. 2 is a simplified depiction of gradient copolymers prepared according to the present invention. Block A represents the alkyl(meth)acrylate monomeric units; and R¹ is a pendant alkyl chain of 20 or more carbon atoms. Block B represents a transition or “gradient” segment containing both alkylacrylate and alkyl(meth)acrylate segments. The alkyl(meth)acrylate units again contain the R¹ alkyl sidechains, while the alkylacrylate monomeric units contain the R² alkyl sidechains. R¹ can be the same size as R², or it can be different, depending on the desired characteristics for the overall copolymer. Block C of the copolymer represents the acrylate monomeric units, containing the R² groups. As described herein, the number of each type of monomeric block unit can be varied, as well as the nature and size of the sidechains, so as to “design” a copolymer best suited for beneficially modifying particular cold-flow properties of an oil.

### EXAMPLES

The following examples illustrate methods and embodiments in accordance with the invention. Unless specified otherwise, all ingredients may be commercially available from such common chemical suppliers as Alpha Aesar, Inc. (Ward Hill, Mass.), Sigma Aldrich (St. Louis, Mo.), Spectrum Chemical Mfg. Corp. (Gardena, Calif.), and the like.

### Example 1

A series of gradient copolymer compositions were prepared, based on selected, branched acrylate/methacrylate monomer units, according to embodiments of the present invention. An ATRP process was employed, using a standard set of reaction conditions. The polymerization initiator was ethyl 2-bromoisobutyrate (EBiB); and the ligand was N,N,N′,N′,N″-pentamethyldiethylenetriamine (PMDTA). As shown in Table 1, the transition metal catalyst was Cu(I)Br for the polymerization of acrylate or copolymers. For the polymerization of (meth)acrylate polymers or copolymes, and gradient polymers or copolymers, the catalyst sytstem was a mixture of Cu(I)Br/Cu(II)Br₂.

The various samples listed in Table 1 that would be considered waxes were prepared in one of two ways, as alluded to previously. Some were prepared by an esterification reaction between the indicated acryalate or methacrylate compound, with a long-chain alcohol, such as one of the Unilin® linear primary alcohols. Other samples were commercially-available materials in which the linear alcohol had already been reacted with an acrylate monomer, e.g., Unlin®350-Acrylate, and acrylate modified wax based on a long-chain Unilin®350 linear alcohol. As also indicated in the table, the co-monomer in some cases was an acrylate or methacrylate without any modification. In other cases, the co-monomer was a modified material, e.g., a linear alcohol esterified with acrylic acid or methacrylic acid, so as to form the desired acrylate or methacrylate, respectively.

The reaction conditions for the Table 1 samples used to prepare copolymers were optimized from a standard set of conditions reported in the literature for the polymerization of acrylates, employing the initiator/catalyst/ligand system of [EBiB]: [Cu(Br)]:[PMDTA] (respectively), discussed prevously. (See “Effect of Variation of [PMDETA]₀/[Cu(I)Br]₀ Ratio On Atom Transfer Radical Polymerization Of N-Butyl Acrylate”, Huang, J., Pintauer, T., Matyjaszewski, K., J. Polym. Sci., Part A: Polym. Chem., 2004, 42, 3285-3292.”. Typically, the ratio of [EBiB]:[Cu(Br)]:[PMDTA] is set to unity [1.0]:[1.0]:[1.0]. As indicated in the table, various reaction solvents were used, i.e., anisole, dimethylformamide, and chlorobenzene.

TABLE 1
Molecular Weight Data and Experimental Conditions Used to Prepare
a Range of Waxy Polymeric Compositions Evaluated Herein

| | | ULILIN | Co- | wt % | DP | Mₙ (×10³) | | [EBiB]:[Cu^{I}]: | |
|---|---|---|---|---|---|---|---|---|---|
| | Example | Monomer | Monomer | UNILIN | Expt. | (GPC) | PDI | [Cu^{II}]:[L]‡ | Solvent† |
| 1779-108 | 1 | 350A | nBA | 10% | 50 | 6.6 | 1.13 | A | PhOMe |
| 1779-109 | 2 | 350A | nBA | 10% | 50 | 5.2 | 1.11 | A | PhOMe |
| 1779-112 | 3 | 350A | nBA | 10% | 35 | 5.2 | 1.35 | B* | PhOMe |
| 1779-113 | 4 | — | nBA | 0% | 35 | 4.7 | 1.48 | B* | PhOMe |
| 1779-122 | 5 | 350A | nBA | 10% | 35 | 4.4 | 1.31 | C | PhOMe |
| 1779-123 | 6 | 350A | nBA | 30% | 35 | 5.2 | 1.24 | C | PhOMe |
| 1779-124 | 7 | 350A | nBA | 10% | 35 | 5.0 | 1.24 | C | PhOMe |
| 1779-125 | 8 | 550A | nBA | 10% | 35 | 6.3 | 1.33 | C | PhOMe |
| 1779-126 | 9 | — | nBA | 0% | 35 | 3.7 | 1.15 | D | PhOMe |
| 1779-127 | 10 | 550A | nBA | 10% | 30 | 3.5 | 1.18 | D | PhOMe |
| 1779-128 | 11 | — | nBA | 0% | 35 | 3.8 | 1.14 | D | PhOMe |
| 1779-130 | 12 | 350A | nBA | 10% | 35 | 4.3 | 1.15 | D | PhOMe |
| 1779-132 | 13 | 350MA | nBMA | 10% | 35 | 4.8 | 1.18 | E | PhOMe |
| 1779-133 | 14 | 350MA | nBMA | 10% | 35 | 4.7 | 1.19 | E | PhOMe |
| 1779-136 | 15 | 350MA | nBMA | 10% | 35 | 4.9 | 1.25 | E | PhOMe/DMF |
| 1779-137 | 16 | 350MA | nBMA | 10% | 35 | 5.4 | 1.24 | E | PhCl/DMF |
| 1779-138 | 17 | 350MA | nBMA | 10% | 35 | 5.4 | 1.26 | F | PhCl/DMF |
| 1779-139 | 18 | 550A | nBA | 30% | 35 | 6.1 | 1.32 | D | PhCl |
| 1779-140 | 19 | 350A | nBA | 50% | 270 | 25.0 | 1.37 | D | PhOMe |
| 1779-141 | 20 | 350MA | nBMA | 50% | 125 | 14.0 | 1.32 | F | PhCl/DMF |
| 1779-142 | 21 | 350MA | SteaMA | 50% | 35 | 8.7 | 1.24 | F | PhCl/DMF |
| 1779-143 | 22 | 550MA | SteaMA | 50% | 35 | 12.0 | 1.22 | F | PhCl/DMF |
| 1779-144 | 23 | 550A | SteaA | 50% | 35 | 8.0 | 1.22 | D | PhCl |
| 1779-145 | 24 | 350A | SteaA | 50% | 35 | 6.0 | 1.24 | D | PhCl |
| 1779-148 | 25 | 550A | nBA | 50% | 35 | 7.0 | 1.13 | D | PhCl |
| 1779-149 | 26 | 550MA | nBMA | 50% | 35 | 6.6 | 1.30 | F | PhCl/DMF |
| 1779-150 | 27 | 350A | nBA | 50% | 35 | 8.3 | 1.37 | D | PhOMe |
| 1779-151 | 28 | 350MA | nBMA | 50% | 35 | 8.2 | 1.20 | F | PhCl/DMF |
| 1779-152 | 29 | 350A | nBA | 50% | 35 | 5.3 | 1.13 | D | PhCl |
| 1779-154 | 30 | 350A | nBA | 50% | 35 | 6.7 | 1.21 | D | PhCl |
| 1779-155 | 31 | 350MA | SteaA | 50% | 35 | 7.9 | 1.32 | F | PhCl/DMF |
| 1779-156 | 32 | 350A | SteaMA | 50% | 35 | 8.9 | 1.27 | F | PhCl/DMF |
| 1782-116 | 33 | 425A | SteaMA | 50% | 35 | 9.5 | 1.23 | F | PhCl/DMF |
| 1782-113 | 34 | 425MA | SteaA | 50% | 35 | 7.0 | 1.24 | F | PhCl/DMF |
| 1782-120 | 35 | 425MA | SteaA | 50% | 35 | 8.6 | 1.43 | F | PhCl/DMF |
| 1782-122 | 36 | LaurMA | LaurMA | 50% | 35 | 8.0 | 1.40 | F | PhCl/DMF |
| 1782-124 | 37 | LaurA | LaurMA | 50% | 35 | 5.7 | 1.37 | F | PhCl/DMF |
| 1779-161 | 38 | SteaMA | SteaA | 50% | 35 | 8.2 | 1.38 | F | PhCl/DMF |
| 1779-162 | 39 | SteaMA | SteaMA | 50% | 35 | 10.0 | 1.40 | F | PhCl/DMF |
| 1782-126 | 40 | 350A | 350MA | 50% | 35 | n.d. | n.d. | F | PhCl/DMF |
| 1782-128 | 41 | 425A | 425MA | 50% | 35 | n.d. | n.d. | F | PhCl/DMF |
| 2145-2 | 42 | 350MA | SteaMA | 50% | 35 | 9.5 | 1.23 | F | PhCl/DMF |

Molecular weight data is reported as referenced against polystyrene standards eluted with 1.0% IPA in CHCl₃.
‡Conditions: [EBiB]:[Cu(I)]:[Cu(II)][L]; A = [1]:[1]:[—]:[1]; B = [1.0]:[0.25]:[—]:[0.50]; C = [1.0]:[0.25]:[—]:[1.0]; D = [1.0]:[0.25]:[—]:[0.55]; E = [1.0]:[0.25]:[1.0]:[0.55]; F = [1.0]:[0.30]:[0.05]:[0.55];
*[Ligand] = Me₂Bipy otherwise PMDTA was used;
†PhOMe = Anisole; DMF = Dimethylformamide; PhCl = Chlorobenzene.

Some comments can be made for the various samples set forth in Table 1. Under the reactions conditions set forth above, the copolymerization of 10 wt % Unilin UL350A in n-butylacrylate produced narrowly dispersed polymer products with higher conversions after 72 hours of reaction time, as compared to 24 hours, as is reflected by the Mₙ values (Examples 1 and 2 in Table 1).

GPC (Gel Permeation Chromatography) traces were obtained to indicate reaction rates and conversion rates, i.e., time-to-reaction-completion. The GPC data indicated that some of the reactions times required to reach reasonable conversion were unsatisfactory. However, considerable improvement in conversion rates was obtained by increasing the [PMDTA]:[Cu(I)Br] ratio. Thus, in some embodiments, the ratio was increased from [1.0]:[1.0] to a much higher ratio of [4.0]:[1.0]. Under these new conditions, with the [EBiB]:[Cu(Br)]:[PMDTA] ratio as [1.0]:[0.25]:[1.0], the complete conversion of monomers was achieved in a considerably shorter reaction time (18 hours), but at the expense of polydispersity. Examples 7 and 6 in Table 1 illustrate this result, and it is also demonstrated by the high molecular weight shoulder that is generated as the polymerization is allowed to proceed to completion.

By optimizing the homopolymerization of n-butylacrylate (Example 9 in Table 1), the most effective ratio of [EBiB]:[Cu(Br)]:[PMDTA] for some embodiments was found to be [1.0]:[0.25]:[0.55]. By applying these reaction conditions to the copolymerization of 10 wt % UL550A in n-butylacrylate, the reaction was complete after 18 hours, and produced a polymer with a narrow molecular weight distribution (See Example 10 in Table 1).

The molecular weight distribution of a 10 wt % UL350A-co-n-butylacrylate polymer was also examined, by comparing GPC gel traces of the product to the starting UL350 acrylate monomer. A set of columns that can separate low molecular weight polymers was employed for this purpose, and the results are shown as Example 12 in Table 1. It should be noted that the UNILIN® alcohols contain approximately 10 wt % of the non-hydroxylated by-product, so one would not expect to see residual amounts of low molecular weight species in the GPC trace at a retention time of approximately 24.0 minutes. Only a fraction of a percent (0.36%) of free UL350A monomer was detected by comparing the integrated regions (plot not shown here) underneath the trace for the polymer peak (retention time of 20 minutes), and the residual UL350A monomer peak (retention time of about 24 minutes).

In an additional set of experiments, the ATRP conditions for the polymerization of the equivalent (meth)acrylate (co)polymer materials were optimized, as illustrated in Examples 13-17 in Table 1. The optimum conditions were obtained by simply adding Cu(II)Br₂, which is used to attenuate the rate of polymerization of (meth)acrylate monomers. (See, for example, Matyjaszewski, K., Xia, J., Chem. Rev., 2001, 101, 2921-2990; and Payne, K. A., D'hooge, D. R., Van Steenberge, P. H. M., Reyniers, M. -F., Cunningham, M. F., Hutchinson, R. A., Marin, G. B., Marcomolecules, 2013, 46, 3828-3840). The polymerization of two separate, but identical, reaction mixtures of 10 wt % UL350MA in n-butyl(meth)acrylate (Example 13) was evaluated, side-by-side, with an [EBiB]:[CuBr]:[CuBr2]:[PMDTA] ratio set to [1.0]:[0.25]: [0.10]:[0.55].

In this optimization experiment, the formation of a green-tarry precipitate 30 minutes after initiation with EBiB was observed. One of these samples, Example 13, was allowed to react undisturbed for 18 hours, while Example 14 was sampled at 2 hours and 3 hours, after initiation with EBiB. The product distribution of the two reaction mixtures was obtained and illustrated as a series of GPC traces (not shown here). Under these conditions, the propagation rates become extremely sluggish after 3 hours, since, even after 18 hours of reaction, the same molecule is also obtained, suggesting that the reaction conditions are less than ideal.

Additional testing with a selected, mixed solvent system (Example 15 in Table 1) appeared to show that the low conversion rate probably related to slow propagation rates; and that the concentration of Cu(II) chain-deactivators was too high. The reaction rates were then “tuned” by the concomitant adjustment of the amount of both Cu(I) and Cu(II) (Example 17 in Table 1). It was found that, by changing the Cu(I)/Cu(II) concentration to give an [EBiB]:[CuBr]:[CuBr₂]:[PMDTA] ratio of [1.0]:[0.30]:[0.05]:[0.55], much higher conversion rates were obtained, with good polydispersity, and under much shorter reaction times (3 hours). In this manner, the ATRP conditions for preparing (co)polymers with about 10-30% loading of selected UL-acrylates (Unilin®) and UL-(meth)acrylates were optimized.

After optimizing the ATRP conditions, the compositional space was expanded to include higher loadings (50 wt %) of the UL-monomers, and to also include waxier (co)monomers of stearyl acrylate (C18), stearyl (meth)acrylate (C18), lauryl acrylate (C12), lauryl (meth)acrylate (C12), UL425 acrylate, and UL425 (meth)acrylate. The ATRP polymerization process was used to simultaneously copolymerize monomer pairs of acrylate and (meth)acrylates to generate additional, gradient copolymers that are different in their backbone architecture, as compared to both random and block (co)polymers prepared by ATRP or by other controlled polymerization reactions.

The materials listed in Table 1 were evaluated as potential wax inhibitors, using a range of surrogate fluids comprising single component waxes in a paraffinic solvent (Exxsol™ D60, from ExxonMobil), or blends of single component waxes in a mixture of aromatic (A150) and Exxsol™ D60 solvents, as shown in Table 2, below. The intrinsic properties of these surrogate fluids are listed in Table 2, and include cloud point (CP) and pour point (PP), information that was obtained with a Phase Technology PCA-70Xi Series Analyzer, according to the standard ASTM methods D5773 and D5949, respectively. CP and PP information about the surrogate fluids with a TA-Instruments AR-G2 rheometer was also obtained, such as the wax appearance temperature (WAT, equivalent to CP) and the “no-flow point” (equivalent to PP), plus the apparent yield stress, which measures the gel strength of the fluid at 5° C. (Table 2).

TABLE 2
Data for the Surrogate Fluids Evaluated in Example 1

| | Cloud | Pour | | Viscosity | WAT | No Flow Point | Apparent Yield |
|---|---|---|---|---|---|---|---|
| Surrogate | Point | Point | Δ(CP − PP) | at 30° C. | (Rheology) | (at 0.44 Pa) | Stress at 5° C. |
| Fluid | (° C.) | (° C.) | (° C.) | (cP) | (° C.) | (° C.) | (Pa) |
| I | 33.0 | 23.0 | 10.0 | 58.0 | 33.8 | 28.5 | 14 |
| II | 34.2 | 13.3 | 20.9 | 13.0 | 35.0 | 25.8 | 5 |
| III | 17.9 | 5.0 | 12.9 | 1.8 | 16.5 | 8.0 | 6 |
| IV | 23.5 | 21.0 | 2.5 | 2.0 | 22.4 | 18.5 | 310 |
| V | 39.7 | 38.0 | 1.7 | n/a | 40.3 | 38.3 | 108 |

The carbon number distribution of these waxy surrogate fluids was obtained from high temperature gas chromatographic analysis; and the compositional makeup was further broken down into the amount of normal paraffin and unknown paraffins. The surrogate fluids highlighted in Table 2 spanned a desirable carbon number region of C₁₈ to C₆₀, with respect to both normal and unknown paraffins. Thus, these materials served as suitable waxy-fluids for evaluating the performance of the additives shown in Table 1.

During initial tests, rheology was used to evaluate the performance of a number of the poly-n-alkylacrylates (Table 1), dosed at 400 ppm of the actives in Surrogate Fluid IV (SF-1V). The results of these experiments are summarized in Table 3, below. For each run, the performance of each additive is compared against the blank and a positive control sample (a modified alpha-olefin maleic anhydride). Clearly, all of the 10 wt % and 30 wt % UL350A- and UL550-co-n-butyl acrylate (co)polymers were not effective at depressing the WAT or NFP properties, or the yield stress of SF-IV. In some instances, the yield stress actually increased by as much as a factor of 2, when comparing its performance to the blank sample.

TABLE 3
A Summary Of The Rheological Characterization Of WAT, NFP, and
Apparent Yield Stress For A Range Of (Co)Polymers in Surrogate Fluid IV*

| | | | | | Viscosity | WAT | No Flow Point | Apparent Yield |
|---|---|---|---|---|---|---|---|---|
| | | ULILIN | Co- | wt % | @30° C. | (Rheology) | (at 0.44 Pa) | Stress at 5° C. |
| SA53 | Example | Monomer | Monomer | UNILIN | (cP) | (° C.) | (° C.) | (Pa) |
| Blank | Blank | | | | 2.0 | 22.4 | 18.5 | 310 |
| 8Q506 | Control | | | | 2.0 | 18.8 | 7.5 | 7 |
| R185 | Control | | | | 2.0 | 19.0 | <5 | None |
| 1779-112 | 3 | 350A | nBA | 10% | 2.0 | 22.3 | 20.3 | 450 |
| 1779-113 | 4 | — | nBA | 0% | 2.0 | 22.3 | 19.3 | 350 |
| 1779-122 | 5 | 350A | nBA | 10% | 2.0 | 22.3 | 20.5 | 450 |
| 1779-123 | 6 | 350A | nBA | 30% | 1.9 | 22.0 | 18.5 | 350 |
| 1779-125 | 8 | 550A | nBA | 10% | 1.9 | 22.5 | 18.8 | 450 |
| 1779-127 | 10 | 550A | nBA | 10% | 2.0 | 22.3 | 19.8 | 550 |
| 1779-139 | 18 | 550A | nBA | 30% | 2.0 | 22.8 | 19.8 | 700 |
| 1779-140 | 19 | 350A | nBA | 50% | 2.0 | 20.0 | 11.3 | 36 |
| 1779-141 | 20 | 350MA | nBMA | 50% | 2.0 | 20.5 | 12.8 | 90 |
| 1779-142 | 21 | 350MA | SteaMA | 50% | 1.9 | 18.3 | 5.3 | 3 |
| 1779-143 | 22 | 550MA | SteaMA | 50% | 2.0 | 22.5 | 19.0 | 360 |
| 1779-144 | 23 | 550A | SteaA | 50% | 2.0 | 20.0 | 8.3 | 18 |
| 1779-145 | 24 | 350A | SteaA | 50% | 2.0 | 18.0 | 8.0 | 22 |
| 1779-150 | 27 | 350A | nBA | 50% | 2.0 | 21.8 | 16.8 | 560 |
| 1779-151 | 28 | 350MA | nBMA | 50% | 2.0 | 21.5 | 16.0 | 220 |
| 1779-155 | 31 | 350MA | SteaA | 50% | 2.0 | 17.6 | 6.3 | 2 |
| 1779-156 | 32 | 350A | SteaMA | 50% | 2.0 | 17.9 | <5 | 7 |
| 1782-116 | 33 | 425A | SteaMA | 50% | 2.0 | 20.6 | 19.0 | ~700 |
| 1782-113 | 34 | 425MA | SteaA | 50% | 2.0 | 20.4 | 10.5 | 35 |
| 1782-120 | 35 | 425MA | SteaA | 50% | 2.0 | 19.0 | 9.3 | 38 |
| 1782-122 | 36 | LaurMA | LaurMA | 50% | 2.0 | 22.3 | 19.0 | 40 |
| 1782-124 | 37 | LaurA | LaurMA | 50% | 2.0 | 22.5 | 19.3 | 200 |
| 1779-161 | 38 | SteaMA | SteaA | 50% | 2.0 | 20.4 | <5 | None |
| 1779-162 | 39 | SteaMA | SteaMA | 50% | 2.0 | 21.6 | <5 | None |
| 1782-126 | 40 | 350A | 350MA | 50% | 2.0 | 21.8 | 15.8 | 310 |
| 1782-128 | 41 | 425A | 425MA | 50% | 2.1 | 23.0 | 18.5 | >500 |

*For each example, the polymers were dosed at an actives concentration of 400 ppm.

For a series of the UL350-co-n-butyl acrylate polymers (examples 3, 6, 27, 19), there appeared to be a correlation between the combination of the wt % loading of UL350 and the molecular weight, to the observed impact on the solution properties of SF-IV (WAT, NFP, and yield stress). For example, the no-flow point data (pour point) for the UL350 acrylate series is 20.3° C., 20.5° C., 16.8° C., and 11.3° C. (examples 3, 6, 27, and 19, respectively). This trend parallels the concomitant increase in both wt % UL350 from 10%, 30%, 50%, and 50%, and Mₙ from 5.2×10³, 5.2×10³, 8.3×10³, and 25.0×10³ Daltons.

A similar trend seems to be present, for the equivalent UL350-co-n-butyl (meth)acrylate (co)polymers (examples 20 and 28). This suggests that both the weight percent loading of the waxier monomer and molecular weight are important for tuning or adjusting the performance of these additives; and that the UL350 monomer, in some embodiments, is more important with respect to performance than the n-butyl acrylate monomer. This relationship is supported further since replacement of the n-butyl (C4) monomer with stearyl (C18) brought about a significant improvement in depressing WAT, NFP, and yield stress for both UL350-co-stearyl acrylate and (meth)acrylate (co)polymers (examples 21 and 24) in SF-IV.

However, there seemed to be an upper limit in the side-chain length of the monomers as well. When UL350 (C25) was replaced with UL550 (C40), the performance appeared to move away from that of a preferred composition; and this phenomenon impacted the (meth)acrylate (co)polymers more than the acrylate (co)polymers. It is unclear at this time whether the observed lower performance of these 50 wt % UL550 (C40) materials is simply related to solubility, or to a more complicated material property.

With some understanding regarding the compositional properties that impact WAT, NFP, and yield stress, a portion of the compositional space for a range of 50 wt % gradient (co)polymers comprised of pairs of the following lauryl/stearyl/UL350/UL450 monomers was explored. The performance of these samples, dosed at 400 ppm of actives in SF-IV, was tested (Table 3, above). The top performing materials within this compositional space in SF-IV are the gradient (co)polymers of UL350A/SteaMA and UL350MA/SteaA (Examples 31 and 32 in the table), along with the gradient (co)polymer of SteaA/SteaMA; and the stearyl (meth)acrylate homopolymer (Examples 38 and 39 in Table 3).

In order to minimize the number of additives screened in surrogate fluid V, using rheology, a simple “jar test” was devised, using surrogate fluids IV and V to identify compositions with promising performance. The test involved heating the surrogate fluid (IV or V) with 400 ppm of the active polymer to a temperature well above the WAT, and, then allowing the solution to cool to room temperature undisturbed, in a jar. A simple grade of “pass” or “fail” was given for samples which effectively precipitated the wax from each solution; and a “fail” for those samples which formed a solid mass and did not exhibit flow when the jar was tilted at 45° , or inverted. (Photographs of the jar-tested samples omitted). The jar test provided a culling of the set of additives, resulting in a smaller selection of random and gradient (co)polymers consisting of Stearyl/UL350/UL425/UL550 acrylates and (meth)acrylates. These materials were evaluated in surrogate fluid V, referenced in Table 2 above. The summary of rheological characterization of the materials is provided in Table 4.

TABLE 4
A Summary of the Rheological Characterization of WAT, NFP, and Apparent
Yield Stress for a Range of (Co)Polymers in Surrogate Fluid V*

| | | | | | Viscosity | WAT | No Flow Point | Apparent Yield |
|---|---|---|---|---|---|---|---|---|
| | | ULILIN | Co- | wt % | @30° C. | (Rheology) | (at 0.44 Pa) | Stress at 5° C. |
| W68 | Example | Monomer | Monomer | UNILIN | (cP) | (° C.) | (° C.) | (Pa) |
| Blank | Blank | | | | n/a | 40.3 | 38.3 | 125 |
| 8Q506 | Control | | | | 2.6 | 37.8 | <5 | None |
| 1779-142 | 21 | 350MA | SteaMA | 50% | 2.4 | 37.8 | <5 | None |
| 1779-144 | 23 | 550A | SteaA | 50% | 96.0 | 37.8 | 29.3 | 110 |
| 1779-145 | 24 | 350A | SteaA | 50% | 4.3 | 36.8 | <5 | None |
| 1779-155 | 31 | 350MA | SteaA | 50% | 3.2 | 37.0 | <5 | None |
| 1779-156 | 32 | 350A | SteaMA | 50% | 2.5 | 37.5 | <5 | None |
| 1782-116 | 33 | 425A | SteaMA | 50% | 2.0 | 38.6 | 5.9 | None |
| 1782-113 | 34 | 425MA | SteaA | 50% | 3.2 | 36.9 | <5 | None |
| 1782-120 | 35 | 425MA | SteaA | 50% | 4.1 | 37.0 | <5 | None |
| 1779-161 | 38 | SteaMA | SteaA | 50% | No Flow | 40.0 | 38.5 | 280 |
| 1779-162 | 39 | SteaMA | SteaMA | 50% | No Flow | 40.1 | 39.0 | 560 |
| 1782-126 | 40 | 350A | 350MA | 50% | 3.5 | 37.0 | 18.8 | 16 |

*For each sample, the polymers were dosed at an actives concentration of 400 ppm.

The data above show that in the SF-V fluid, the materials comprising UL350 or UL425 with stearyl co-monomer pairs clearly outperformed the materials made up entirely of stearyl monomers. The (co)polymers comprised of only C₁₈ side-chains (examples 38 and 39 in Table 4) did not depress either WAT or NFP, and they actually increased the yield stress from the baseline value for the untreated sample. All of the other materials listed in Table 4 exhibited the ability to depress WAT and NFP.

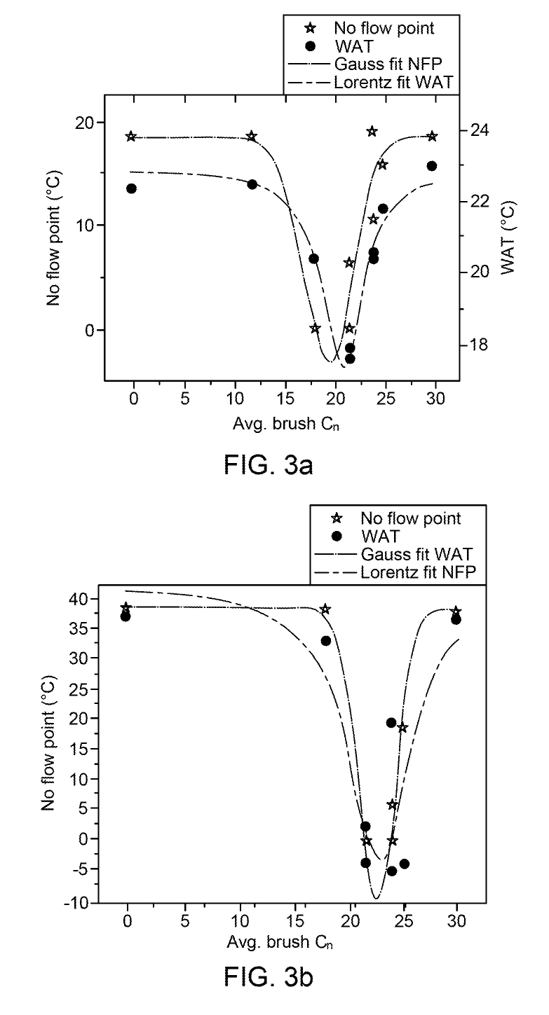

FIG. 3 is, in part, another representation of the data expressed in Table 4. The plots represent average side-chain carbon number to the measured NFP values (black stars), and WAT values (blue circles), for a range of gradient (co)polymers in (a) surrogate fluid IV (the upper graph) and (b) surrogate fluid V (the lower graph). The data has been fitted with curves to highlight the region of maximum performance, with respect to the average Cₙ of the brushed gradient (co)polymers.

With reference to FIG. 3 and Table 4, a trend can be seen in the rheological NFP and WAT data for the 50 wt % gradient (co)polymers, after plotting the data of FIG. 3. The curve fitting highlights an area of optimum performance that is centered at an average brush-Cₙ of 20 and 23, for SF-IV and SF-V, respectively. The differences observed in the performance of these additives tracks fairly closely to the average Cₙ distribution for each surrogate. For these fluids, the average Cₙ for normal paraffins is 27 and 34 for SF-IV and SF-V, respectively; and the differentials between these averages and the peak distribution in performance is 7 and 11. It is difficult to account for these unequal differences in peak Cₙ performance to the Cₙ distribution, but it is more than likely related to the differences in the overall makeup of the fluids. Specifically, the ratio of normal paraffins and isoparaffins is substantially different for each fluid. The higher quantity of isoparaffins in SF-V might skew the distribution to lower values, because of some important underlying interaction with the isoparaffins and the normal paraffins in the surrogate fluid.

### Example 2

The following samples evaluated for their cold flow properties were prepared by dissolving the appropriate amount of polymer in xylenes to generate a range of solutions that cover the range of 5 wt % to 20 wt % solids as determined on a moisture balance. The cold flow properties of a range of additives was assessed by determining (1) the onset of gelation using a Herzog Pour Point/Cloud Point instrument and (2) the change in viscosity of samples that are cooled under a constant shear. For the gel point experiment, the ASTM D 97 method was deployed and the samples were manually observed during each tilt cycle. The gel point was determined by eye and the temperature for the gel point was determined at the point at which the sample was no longer fluid. Rheology experiments were performed on the TA-Instruments AR-G2 stress controlled rheometer using a Couette geometry, which has an inner cylinder diameter of 28 mm and an outer cup diameter of 30 mm. In each instance, the sample was conditioned at 65° C. for 15 minutes. Then, the sample was cooled from 65° C. to 5° C. at a rate of 1.0° C./min while monitoring the change in viscosity. The tests were terminated once the sample had reached a viscosity limit of 100 cP, or when the temperature reached the terminal temperature limits of the cooling system (−10° C.).

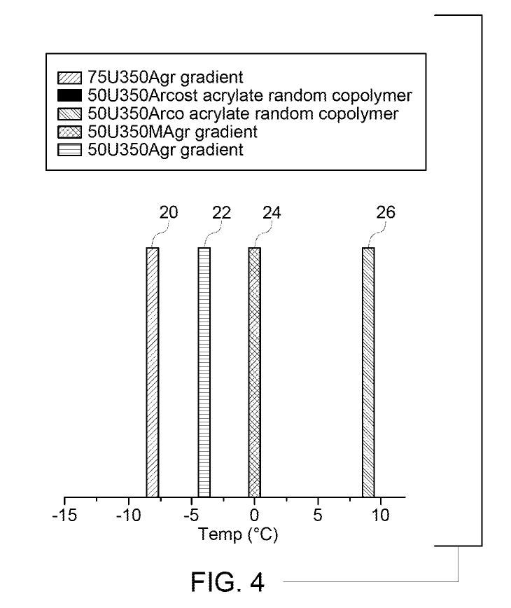

In FIG. 4, three gradient copolymers were examined: a 50/50 by wt % [UNILIN350acrylate]-gradient-[C₁₈(meth)acrylate] (bar 22); a 50/50 by wt % [UNILIN350(meth)acrylate]-gradient-[C₁₈-acrylate] (bar 24), and a 75/25 by wt % [UNILIN350acrylate]-gradient-[C₁₈(meth)acrylate] (bar 20) are compared against two 50/50 by wt % [UNILIN350acrylate]-co-[C₁₈acrylate] polymers (represented by bar 26). The two, last-mentioned acrylate copolymers (bar 26) were prepared under ATRP or conventional methods, respectively, and these two polymers represent a good portion of types of polymers prepared as homopolymers or mixtures of homopolymers of (meth)acrylates or acrylates disclosed in U.S. Pat. No. 6,218,490 (Examples I-XIV).

With continued reference to FIG. 4, it was determined that a significant contributor to poor solubility or poor formulation stability can be attributed to the high degree of crystallization of the side chains for the purely (fully)-acrylate homopolymer. The unexpected benefit of the gradient copolymers becomes apparent, in that the three gradient-copolymer all have significantly improved formulation stability and gel at temperatures that are 10 to 16° C. lower than the fully acrylate copolymers shown in FIG. 4. The two fully-acrylate copolymers had Mₙ values <10 K. Even at these significalty low Mₙ values, the two 10 wt % xylenes solutions of the acrylate-acrylate gelled at 9° C. It is important to note that the molecular weight of the polymers disclosed in U.S. Pat. No. 6,218,490 are extremely high, with Mₙ ranging from 22 K to 440 K. At these high Mₙ values it can be speculated that 10 wt % formulations of these polymers would exhibit poor product stability.

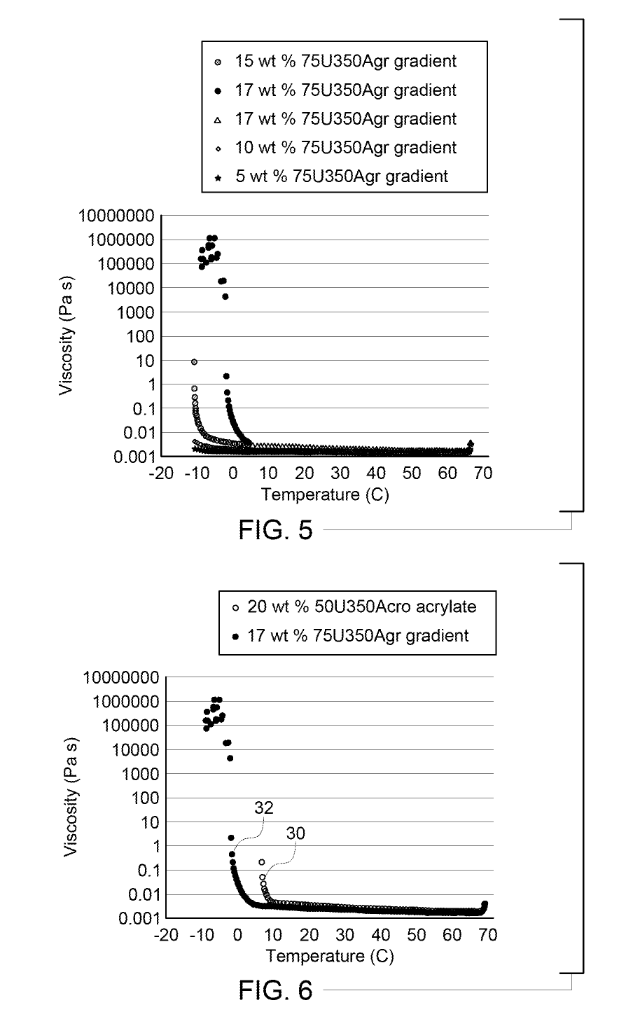

In addition to the simple assessment of formulation gel point, the differences in product stability for a range of concentrations of 75/25 by wt % [UNILIN™350acrylate]-gradient-[C₁₈(meth)acrylate] were also compared. Reference is made to FIGS. 5 and 6, which provide rheological data that show a relationship between a decrease in temperature and an increase in viscosity, for (A) a range of concentrations for the 75U350A gadient copolymer and (B) a comparison between a “purely” acrylate 50U350Arco random copolymer and a 75U350 gradient copolymer.

With continued reference to FIGS. 5 and 6, it can be seen that at concentrations that are lower than 10 wt % solids, the 75/25 by wt % [UNILIN™350acrylate]-gradient-[C₁₈(meth)acrylate] copolymers have solution viscosities that are lower than 10 cP at −10° C. A direct comparison was also made between a fully 50U350Arco acrylate random copolymer to the 75U350Agr gradient copolymer, at higher solids loading that approach 20 wt % solids shown in FIG. 6. The gradient polymer which contains 25% more of the acrylate monomer with the “waxier” sidechain should typically cause gelation. Surprisingly, the sample had a marked and unexpected improvment in formulation stability, as compared to the 50U350Arco acrylate random copolymer. (The comparison is between curves 30 (“fully acrylate”) and 32 (gradient), starting from the right side of the X-axis, i.e., at about 50° C., and moving toward the left, with decreasing temperature. Curve 30 exhibits an increase in viscosity more quickly (i.e., at a higher temperature) than curve 32 of the present invention, with the latter showing better low-temperature behavior).

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1) A process for improving the cold-flow properties of an oil that contains at least one paraffinic hydrocarbon material, comprising the step of contacting the oil with a gradient copolymer formed by a controlled free-radical polymerization technique or by reversible deactivation radical polymerization;
wherein the gradient copolymer comprises at least one polymer chain having both an alkylacrylate monomeric unit and an alkyl(meth)acrylate monomeric unit; and the polymer chain is further characterized by a gradual transition in monomeric composition between the alkylacrylate unit and the alkyl(meth)acrylate unit;
and at least one of the alkylacrylate or alkyl(meth)acrylate monomeric units contains at least one pendant alkyl chain of 12 or more carbon atoms.

2) The process of claim 1, wherein the controlled free-radical polymerization technique is reversible addition fragmentation chain transfer polymerization (RAFT).

3) The process of claim 1, wherein the controlled free-radical polymerization technique is nitroxide-mediated polymerization (NMP).

4) The process of claim 1, wherein the controlled free-radical polymerization technique is atom-transfer radical polymerization (ATRP).

5) The process of claim 1, wherein the paraffinic hydrocarbon material in the oil contains at least one alkyl chain of an average carbon length of 20 or more carbon atoms; and wherein the pendant alkyl chain on the alkylacrylate or alkyl(meth)acrylate monomeric units of the gradient copolymer matches the carbon length of the paraffinic material, within about 20% of the carbon chain length.

6) The process of claim 1, wherein the weight ratio between the alkylacrylate monomer and the alkyl(meth)acrylate monomer is in the range of about 5:95 to about 95:5.

7) The process of claim 6, wherein the weight ratio between the alky acrylate monomer and the alkyl (meth)acrylate monomer is in the range of about 15:85 to about 85:15.

8) The process of claim 1, wherein there is at least one pendant alkyl chain on the alkylacrylate or alkyl(meth)acrylate monomeric units.

9) The process of claim 8, wherein the pendant alkyl chain on the alkyl(meth)acrylate monomeric unit contains 20 or more carbon atoms.

10) The process of claim 1, wherein the alkyl(meth)acrylate monomeric unit is a methyl (meth)acrylate-based wax having a pendant chain length in the range of about 20 to about 50 carbon atoms.

11) The process of claim 10, wherein the methyl (meth)acrylate-based wax is formed by the esterification of methacrylic acid and a linear alcohol having at least about 20 carbon atoms.

12) The process of claim 1, wherein the alkylacrylate monomeric unit is a methyl acrylate-based wax having a pendant chain length in the range of about 20 to about 50 carbon atoms.

13) The process of claim 12, wherein the methyl acrylate-based wax is formed by the esterification of acrylic acid and a linear alcohol having at least about 20 carbon atoms.

14) The process of claim 4, wherein the gradient copolymer is prepared by polymerizing the unsaturated precursors to an alkylacrylate monomer and an alkyl(meth)acrylate monomer, in the presence of
a) a reversible-deactivation radical polymerization initiator that contains a transferable atomic group;
b) at least one catalyst that contains a transition metal; and
c) at least one ligand that is capable of forming a coordination compound with the transition metal;

15) The process of claim 14, wherein the polymerization initiator is selected from 2,2′-azobisisobutyronitrile (AIBN); 1,1′-azobis(cyclohexanecarbonitrile); 2,2′-azobis(2,4-dimethylvaleronitrile); dimethyl 2,2-azobis(2-methylpropionate); benzoyl peroxide; and lauroyl peroxide.

16) The process of claim 14, wherein the reversible-deactivation radical polymerization initiator that contains a transferable atomic group is selected from benzyl halides; carboxylic acid derivatives that are halogenated in the α position; tosyl halides;
alkyl halides; and halogen derivatives of phosphoric acid esters.

17) The process of claim 14, wherein the catalyst comprises a transition metal selected from Cu (copper), Fe, Co, Cr, Ne, Sm, Mn, Mo, Ag, Zn, Pd, Pt, Re, Rh, Ir, In, Y, and Ru.

18) The process of claim 17, wherein the catalyst is selected from CuBr, CuBr₂, CuCl, CuI, CuN₃, CuSCN, CuCN, CuNO₂, FeBr₂, CrCl₂, and NiBr₂.

19) The process of claim 14, wherein the ligand of component (c) is selected from tetramethylethylenediamine (TMEDA); N,N,N′N′,N″-pentamethyldiethylenetriamine (PMDTA); N,N,N′,N′-tetrakis(2-pyridylmethyl)ethylenediamine (TPyEN); sparteine; triphenylphosphine; and combinations thereof.

20) A method of transporting petroleum crude oil that contains dissolved wax through a pipeline, comprising the steps of contacting the crude oil with a gradient copolymer formed by a controlled free-radical polymerization technique or by reversible deactivation radical polymerization; so as to form a treated oil composition that exhibits improved flow properties; and then pumping the treated oil composition through the pipeline to a desired location; wherein
the gradient copolymer comprises at least one polymer chain having both an alkylacrylate monomeric unit and an alkyl(meth)acrylate monomeric unit; and the polymer chain is further characterized by a gradual transition in monomeric composition between the alkylacrylate unit and the alkyl(meth)acrylate unit;
and at least one of the alkylacrylate or alkyl(meth)acrylate monomeric units contains at least one pendant alkyl chain of 12 or more carbon atoms.
